(19) United States
(12) Patent Application Publication
(10) Pub. No.: US 2013/0205662 A1
(43) Pub. Date: Aug. 15, 2013

(54) SELF-CONTAINED AUTOMATIC PLANT WATERING APPARATUS SYSTEM AND METHOD FOR OPERATING SAME

(71) Applicants: James Yancey, Ocala, FL (US); Rhett Butler, St. Simons Island, GA (US)

(72) Inventors: James Yancey, Ocala, FL (US); Rhett Butler, St. Simons Island, GA (US)

(21) Appl. No.: 13/396,140

(22) Filed: Feb. 14, 2012

(51) Int. Cl. A01G 27/02; A01G 9/02

(52) U.S. Cl. 47/66.6; 47/79; 47/65.5

(57) ABSTRACT

An automatic plant watering apparatus and method for operating are disclosed. The apparatus includes a container configured to hold soil elements sufficient to support a plant, a base module configured to secure and support the container, a pump configured to move fluid from a reservoir of the base module to the container when selectively controlled, and a control system configured to selectively control the pump based upon user inputs and monitored time. The control system is configured to receive user inputs associated with time periods for water pumping to the container. The container and base module are connected whereat a drain hole is coupled to a piping structure of the base module.

### TECHNICAL FIELD

This disclosure relates generally to methods and apparatus for plant caretaking, and more particularly to automatic, self-contained apparatus for plant storage and watering.

### BACKGROUND

The statements in this section merely provide background information related to the present disclosure and may not constitute prior art.

Many plants are grown in pots and other containers in homes and outside living areas. For most plant varieties and conditions, periodic, manual watering is necessary to keep the plant alive and healthy. This process can be difficult or inconvenient, however, as people can be unavailable to water the plant or simply forget. When this occurs, the plants' heath can suffer causing withered leaves and/or death. Maintaining healthy plants is important because they bring beauty to the area they are in, enhance the quality of the air, and are often expensive to purchase.

Depending on the species and size of the plant in question, the volume and time of watering may vary greatly. For example, some plants need to be watered each day and others only need water a few times a week. This scheduling information requires the caretaker of the plant to continually remember multiple schedules when taking care of multiple plants since overwatering or underwatering houseplants puts the health of the plants at risk. Furthermore, the absence of the caretaker for any duration necessitates arranging for others to care for the plants and hope that they are diligent regarding the watering schedule for each plant.

Accordingly, there remains a need for a device capable of automatically watering houseplants and the like at regular intervals, thus relieving the owner of the task of periodic watering.

### SUMMARY

An automatic plant watering apparatus and method for operating are disclosed. The apparatus includes a container configured to hold soil elements sufficient to support a plant, a base module configured to secure and support the container, a pump configured to move fluid from a reservoir of the base module to the container when selectively controlled, and a control system configured to selectively control the pump based upon user inputs and monitored time. The control system is configured to receive user inputs associated with time periods for water pumping to the container. The container and base module are connected whereat a drain hole is coupled to a piping structure of the base module.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows one embodiment of an automatic plant watering apparatus that is useful for understanding the embodiments disclosed herein.

FIG. 2 schematically shows an automatic plant watering apparatus, in accordance with one embodiment of the present disclosure.

FIG. 3 shows an exemplary embodiment of the automatic plant watering apparatus, in accordance with one embodiment of the present disclosure.

FIG. 4 is a block diagram illustrating a system for operating the plant watering apparatus, in accordance with one embodiment of the present disclosure.

FIG. 5 shows a control scheme for operating the plant watering apparatus and system, in accordance with the present disclosure.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

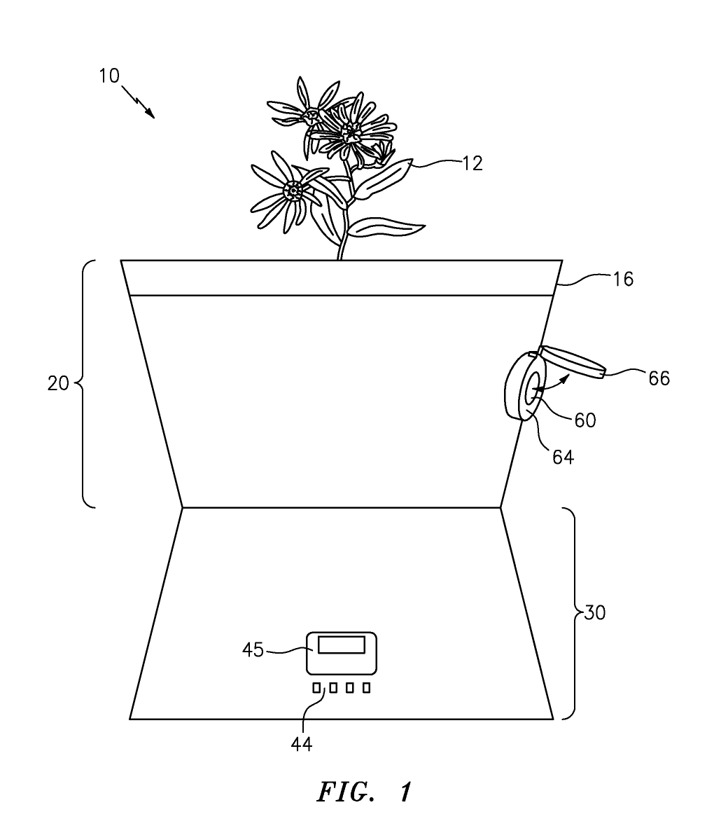

For purposes of this description, the terms “upper,” “bottom,” “right,” “left,” “front,” “vertical,” “horizontal,” and derivatives thereof shall relate to the invention as oriented in FIG. 1.

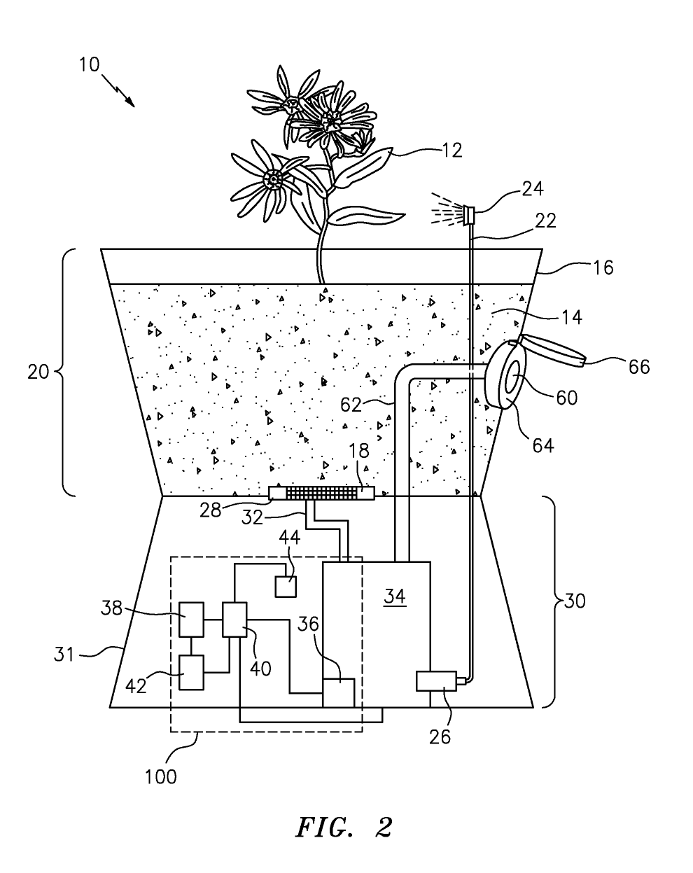

FIGS. 1 and 2 illustrate one embodiment of an automatic plant watering apparatus 10 configured as substantially described herein to water a plant 12. The apparatus 10 can include a container 20 and a base module 30 configured to house a control system 100 and various pumping components.

The container 20 and base module 30 are preferably connected to form a single unit when operational. The container 20 may be connected to the base module using any number of known connection methods and devices, such as a screw, or adhesive member.

The container 20 is configured to contain soil 14 including water and nutrients sufficient to support and/or grow the plant 12. The container 20 may be any size and shape sufficient to contain the soil 14 and support the plant 12. To this end, the present disclosure is not to be construed as limited to the shape depicted in exemplary illustration FIG. 1.

As shown, the container 20 can preferably include a frustoconical-shaped member, having conical-shaped walls to direct water and nutrients downward via gravity. Housing 16 of the container 20 may be formed of any known material configured to hold and support the plant 12 and accompanying soil 14. In one embodiment, the housing is formed of polymer-based material such as common plastics. The bottom of the container 20 can further include a drain hole 18 fitted with a screen 28 or other filtering structure configured to permeate water through the drain hole and into the base module 30. In one embodiment, the bottom portion of the housing 20 can include a sloped portion within a range of 5 to 25-degrees for directing water into the drain hole 18.

In one embodiment, the housing 16 can include an opening 60 adapted to provide access to a reservoir 34 via a reservoir line 62. Access to the opening 60 is preferably controlled using a lid 64 and cover 66. The lid 64 and cover 66 may be formed from the same material as the container 20. The cover 66 can be integrally formed with the lid 64, e.g., a flip-top snap-on cover, or can be separate from the lid 64, e.g., a screw-on cover. In one embodiment, the cover 66 may coupled to the lid 64 via a hinge that may formed separately. The cover 66 can include other sealing means such as an o-ring, such that when closed over the lid 64 a seal (e.g., a liquid tight seal, a hermetic seal, etc.) is formed with the lid 64.

The base module 30 is configured to act as a stand for displaying and supporting the container 20 in an aesthetically pleasing manner. Additionally, the base module 30 can act to house a control system 100 for controlling the operations of the apparatus, and can be connected to a pump 26, and the reservoir 34. The base module 30 may be any size and shape sufficient to secure and support the container 30. Housing 31 of the base module 30 may be formed of any known material including polymer based materials such as common plastics.

The pump 26 is configured to generate a hydraulic pressure in a supply line 22 to a nozzle 24 configured to emit pumped fluid (such as water, for example) from the reservoir 34. As shown, the supply line 22, according to one embodiment, can pass through the interior of both the container 20 and the base module 30 in order to deposit water directly to the plant 12. However, in an alternate embodiment, supply line 22 can be routed along the outside of one or more of the container 20 and base module 30. Finally, although illustrated as including a nozzle 24 located above the soil 14, one of skill in the art will recognize that subterranean nozzles can also be utilized without deviating from the scope and spirit of the inventive concepts disclosed herein.

The pump 26 is communicatively connected to the control module 40 of the system 100. To this end, the pump can be remotely activated by the system in one or more operating states such as an OFF operating state and an ON operating state. In one embodiment, the pump 26 is a variable speed pump configured to operate at selectable output levels. In one embodiment, the pump 26 is additionally configured for user manipulation.

The reservoir 34 is a container configured to hold a water reserve to be pumped to the container 20. As will be described below, the reservoir 34 can be connected to the drain line (piping structure) 32 in order to reuse water not absorbed by the plant and/or soil. Reservoir 34 is also connected to the opening 60 via the reservoir line 62 in order to receive fresh water from a user. Moreover, the water reserve may additionally include plant nutrients or fertilizer, and may be capped to prevent spills.

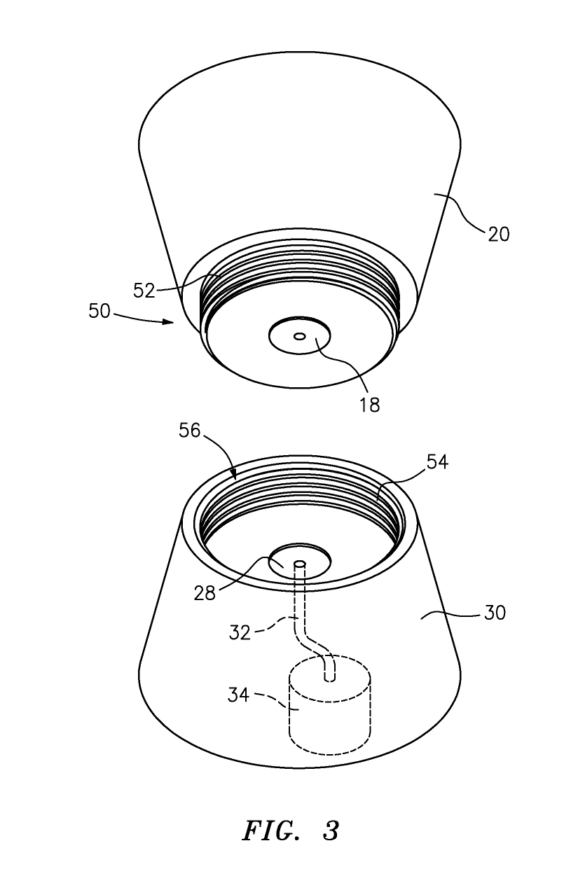

FIG. 3 illustrates an alternate embodiment of the automatic plant watering apparatus 10 that includes a rotating connection means for securing the container 20 to the base module 30. The rotating connection means couples the container 20 to the base module 30 by rotating the container 20 into the base module 30. As shown, the container may include a fastening component 50 configured to thread into a receiving aperture having correspondingly internal threads. The fastening component 50 is preferably circularly-shaped and includes threads 52 spirally grooved on a surface. The fastening component 50 may be adapted as a simple machine of the inclined plane type, e.g., tapered, to generate compression forces when secured to a receiving aperture.

Likewise, the base module 30 preferably includes an aperture 56 having spiral grooves configured to receive the fastening component 50. The aperture 56 may be circular-shaped and have tapered i.e., a conical-shaped decline, configured to generate compression forces when receiving the fastening component 50. The fastening component 50 and aperture 56 may be any size adapted to secure the container 20 to the base module 30.

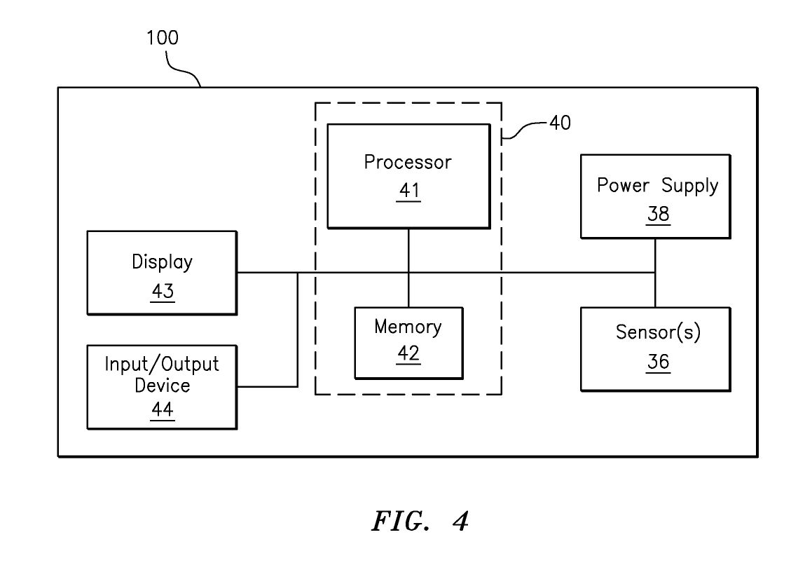

FIG. 4 illustrates a block diagram of the control system 100 according to one embodiment. As shown, system 100 can include a control module 40 having a processor 41 that is communicatively linked to a memory 42, a display 43, an input/output device 44, a power supply 38, and one or more sensors 36. The power supply 38 may be any known type of an electrical energy storage device such as rechargeable batteries.

The processor 41 can act to execute program code stored in the memory 42 in order to allow the device to perform the functionality described herein. Processors are extremely well known in the art, therefore no further description will be provided.

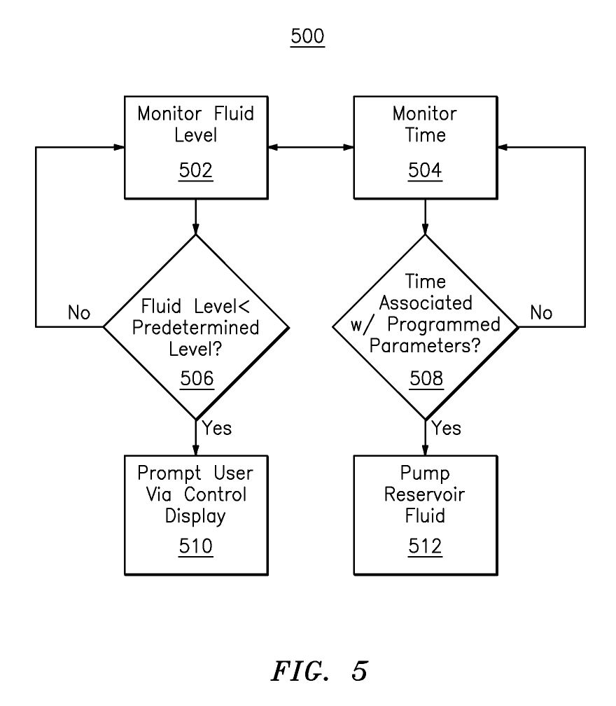

Memory 42 can act to store operating instructions in the form of program code for the processor 41 to execute. Although illustrated in FIG. 5 as a single component, memory 42 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 42 can also include one or more cache memories that provide temporary storage of at least some program code in order to reduce the number of times program code must be retrieved from the bulk storage device during execution. Each of these devices are well known in the art. To this end, the memory 42 can act to receive instructions from a user (via the input/output device 44, for example) regarding a time and duration for activating the pump 26 to water the plant 24.

Although described above as including a processor, one of skill in the art will recognize other suitable devices, such as a logic device(s), for example, can be utilized to provide the desired functions. Moreover, one skilled in the art will recognize that the control module 40 executes functions in accordance with any one of a number of resident instructions. The description of the control module 40 is meant to be illustrative, and not restrictive to the disclosure, and those skilled in the art will appreciate that the disclosure may also be implemented on any number of platforms and/or operating systems. In either instance, it is preferred that the control module 40 includes a clock to track time and enable an operator to store desired watering schedules into the memory 42, for the processor 41 to execute.

In one preferred embodiment, the power source 38 can include one or more DC batteries capable of providing the necessary power requirements to each element of the apparatus 10. In an alternate embodiment (not shown) the power source can include a common A/C electrical power transformer capable of allowing the self watering apparatus 10 to be powered from a standard electrical outlet.

The one or more sensors 36 may be any number of devices configured to monitor or determine fluid level in the reservoir 34. For example, the sensor 36 may be an optical, radar, or sonar-based sensor configured to measure distance of the liquid from the physically affixed sensor. Other devices that may be utilized to monitor fluid level in the reservoir 34 include floats, hydrostatic devices, load cells, magnetic level gauges, and capacitance transmitters, as are well understood by those skilled in the art.

The display 43 can be an optical display or other visual indicator which displays system information such as an electrical energy level of the power supply 38 and fluid level of the reservoir 34. In one embodiment, the display 43 can include a plurality of LED elements to indicate the fluid level and/or an indication of the electrical energy level. For example, an illuminated red LED element may indicate a low level, a yellow LED element may indicate a medium level, and a green LED element may indicate a sufficient level. The display 43 preferably is configured to display control functions selected or selectable by the user through the I/O unit 44.

For example, timing functions are preferably inputted and subsequently displayed on the display 43. The display 43 may be connected to the control module 40 by an internal bus system. The display 43 may be configured to display a user interface system configured to display user controls, selections, and other operational information.

The input/output unit 44 can include an number of push buttons configured to accept user inputs and provide instructions to the processor. In one preferred embodiment, each of the buttons can be connected to the processor 41 so as to activate different programmatic functions. Moreover, each button can contain a unique marking for instructing a user as to the function each button performs.

For example, one push button can act to initiate programming for instructing the processor 41 to immediately activate the pump 26. In another example, a second push button can act to store a desired watering schedule within the memory 42 for the processor to execute at a later time. Although described above as a push button, one of skill in the art will recognize that any number of different input devices ranging from a switch, to a keypad, for example, can also be utilized.

In an alternate embodiment, the functionality of both the input/output unit 44 and the display 43 can be combined in the form of a Graphic User Interface (GUI) 45 configured to provide two way communication with a user. To this end, GUI screen 45 can include a touch screen monitor (color or monochrome) for providing a menu of actions that a user can select for instructing the system to perform.

FIG. 5 shows a control scheme 500 for operating the apparatus 10. Although the control scheme is shown as discrete elements, such an illustration is for ease of description and it should be recognized that the functions performed by the control scheme may be combined in one or more devices, e.g., implemented in software, hardware, and/or application-specific integrated circuitry (ASIC). For example, the control scheme 500 may be implemented in the control system 100.

In operation, the apparatus 10 monitors fluid level 502 and time 504, concurrently or sequentially. User inputs are utilized by the control module 40 to establish time operating parameters for activating the pump 26. For example, in one embodiment, a user may set a specific daily time and/or a weekly schedule wherein days are associated with specific operating times. The specific operating times may be associated with a time range. For example, a user may specify 7 p.m. and select an operating time of 3 minutes. If the monitored time is associated with a programmed time parameter 508, i.e., a specified time, then the control module 40 controls the pump 26 to an ON operating state. However, if the monitored time is not associated with a programmed time parameter, then the control module 40 continues to monitor time, leaving the pump 26 in the OFF operating state. After pumping in step 512, fluid mixtures, including water from the reservoir 34, seep through the soil 14 to the drain hole 18 and screen 28. The fluid flows through a piping structure 32 to the reservoir 34 where it may be pumped back to the container 20 via the supply line 22 and nozzle 24.

Concurrently or sequentially, the control scheme 500 monitors fluid level 502 and determines whether the fluid level corresponds to a predetermined level 506. In one embodiment, if the fluid level is less than a predetermined level, then the control module 40 controls the display 510 by signaling the display 43 to indicate a first level, e.g., red LED light. If, however, the monitored fluid level is greater than the predetermined level the control module 40 signals the display to indicate a second level, e.g., green LED light. The LED lights may be controlled to emit continuous light or flashing lights.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An automatic plant watering apparatus, comprising:
a container configured to hold soil elements sufficient to support a plant, the container having a drain hole;
a base module configured to secure and support the container, the container and base module connected whereat the drain hole is coupled to a piping structure of the base module;
a pump configured to move fluid from a reservoir of the base module to the container when selectively controlled; and
a control system configured to selectively control the pump based upon user inputs and monitored time.

2. The apparatus of claim 1, wherein the user inputs comprise a range of time.

3. The apparatus of claim 1, wherein the user inputs comprise a specific time.

4. The apparatus of claim 1, wherein the control system controls the pump to an ON operating state when the user inputs correspond to a monitored time.

5. The apparatus of claim 4, wherein the control system controls the pump to an OFF operating state a predetermined time period subsequent to controlling the pump to an ON operating state.

6. The apparatus of claim 1, further comprising:
a fluid level sensor, the sensor communicatively connected to the control system and configured to communicate a fluid level.

7. The apparatus of claim 6, further comprising: a plurality of LED lights configured to indicate the fluid level.

8. The apparatus of claim 6, wherein a monitored fluid level less than a predetermined threshold is indicated using a flashing red LED light.

9. The apparatus of claim 6, wherein a monitored fluid level greater than a predetermined threshold is indicated using a green LED light.

10. The apparatus of claim 1, further comprising:
a plurality of LED lights configured to indicate an electrical energy power level of an electrical energy storage device.

11. A method for watering a plant, the method comprising:
coupling a plant holding container to a base module having an electric pump selectively controlled using a timer;
receiving user inputs associated with a time schedule;
monitoring time; and
controlling the pump based upon the monitored time and the received user inputs.

12. The method of claim 11, further comprising:
monitoring fluid level of a fluid reservoir within the base module; and
indicating the fluid level using a plurality of LED lights.

13. The method of claim 11, further comprising:
monitoring an electrical energy power level of an electrical energy storage device; and
indicating the monitored electrical energy power level using a plurality of LED lights.

14. The method of claim 11, wherein the user inputs specify a daily time.

15. The method of claim 11, where in the user inputs specify a weekly schedule.

16. The method of claim 11, further comprising:
controlling the pump to an ON operating state when a time associated with the user inputs is substantially equal to the monitored time.

17. The method of claim 16, further comprising:
controlling the pump to an OFF operating state after a predetermined time period elapses from controlling the pump to the ON operating state.

18. An automatic plant watering apparatus, comprising:
a frustoconical-shaped container configured to hold soil elements sufficient to support a plant, the container having a drain hole;
a base module configured to secure and support the container, the container and base module connected whereat the drain hole is coupled to a piping structure of the base module;
a pump configured to move fluid from a reservoir of the base module to the container when selectively controlled; and
a control system comprising: a display device configured to display operating information, a user input device configured to receive user input information, and a time configured to monitor time, the control system configured to selectively control the pump based upon the user input information and monitored time.

19. The apparatus of claim 18, wherein the display device comprises a plurality of LED lights.

20. The apparatus of claim 18, further comprising:
a fluid level sensor, the sensor communicatively connected to the control system and configured to communicate a fluid level.

21. The apparatus of claim 18, wherein the base module is frustoconical-shaped with a downward slope within a range of 5 to 25-degrees.

22. The apparatus of claim 18, wherein the container and base module are connected using a threaded connection means comprising a spirally threaded fastening component and a spirally grooved aperture configured to receive the threaded fastening component.
